(19) United States
(12) Patent Application Publication
(10) Pub. No.: US 2019/0191126 A1
(43) Pub. Date: Jun. 20, 2019

(54) SYSTEMS AND METHODS FOR MONITORING STREAMING FEEDS

(71) Applicant: Steven M. GOTTLIEB, New York, NY (US)

(72) Inventor: Steven M. GOTTLIEB, New York, NY (US)

(21) Appl. No.: 16/222,490

(22) Filed: Dec. 17, 2018

Related U.S. Application Data
(60) Provisional application No. 62/599,883, filed on Dec. 18, 2017.

(51) Int. Cl. H04N 7/18; G06K 9/00; H04N 5/445

(52) U.S. Cl. CPC H04N 7/181; G06K 2009/00738; H04N 5/44591; G06K 9/00718

(57) ABSTRACT

Systems and methods are provided herein. In an exemplary embodiment, a method for displaying a plurality of streaming feeds is provided. A first and second streaming feed may be received from a first and second device, respectively. Upon detecting an occurrence based on data received from the second streaming feed, video and/or audio data from the second streaming feed may be displayed. In another exemplary embodiment, a composite video is provided. First and second video data may be received from a first and second device, respectively. The first and second video data may be displayed on a display screen at the same time.

### CROSS-REFERENCE TO RELATED APPLICATIONS

This application claims priority from U.S. Provisional Patent Application No. 62/599,883, filed on Dec. 18, 2017, which is hereby incorporated in its entirety by this reference.

### SUMMARY OF THE INVENTION

This disclosure is generally directed to systems and methods for monitoring multiple streaming feeds.

In one embodiment, what may be disclosed is a method comprising: receiving, from a first device, a first streaming feed comprising first audio data and first video data; receiving, from a second device, a second streaming feed comprising second audio data and second video data; displaying, on a display screen, the first video data; detecting, based on the second streaming feed, an occurrence; displaying, based on detecting the occurrence, the second video data on the display screen; and storing, in memory, data representing the second streaming feed.

In another embodiment, what may be disclosed is a system, comprising: a first device comprising a first camera operable to capture first video data, and a first microphone operable to capture first audio data; a second device comprising a second camera operable to capture second video data, and a second microphone operable to capture second audio data; communications circuitry; memory; a display screen; and a processor operable to: receive, from the first device, a streaming feed captured by the first camera; receive, from the second device, a streaming feed captured by the second camera; display, on the display screen, the first video data; detect, based on the second streaming feed, an occurrence; display, based on the occurrence, the second video data on the display screen; and store, in the memory, data representing the second streaming feed.

In another exemplary embodiment, what may be disclosed is method comprising: receiving, from a first device, a first streaming feed comprising first audio data and first video data; receiving, from a second device, a second streaming feed comprising second audio data and second video data; displaying, on a display screen, composite video data comprising the first video data and the second video data.

### DESCRIPTION OF THE DRAWINGS

The above and other features of the present invention, its nature and various advantages will be more apparent upon consideration of the following detailed description, taken in conjunction with the accompanying drawings in which:

FIGS. 1A-1D are schematic views of illustrative communications systems in accordance with various embodiments;

FIG. 2 is an illustrative diagram of a composite display, in accordance with various embodiments; and

FIGS. 3A and 3B. are illustrative diagrams of a system for displaying a composite view, in accordance with various embodiments.

### DETAILED DESCRIPTION

The present invention may take form in various components and arrangements of components, and in various techniques, methods, or procedures and arrangements of steps. The referenced drawings are only for the purpose of illustrated embodiments, and are not to be construed as limiting the present invention. Various inventive features are described below that can each be used independently of one another or in combination with other features. Furthermore, in at least some embodiments, liked referenced numerals refer to like parts throughout.

Many difficulties arise when attempting surveillance on multiple targets. These difficulties amplify greatly as the number of targets increase. For instance, when attempting to monitor hundreds (or even dozens) of streaming feeds, keeping track of each feed becomes an arduous task, requiring more and more people actively monitoring each feed. In addition, one notable reason for monitoring streaming feeds is to capture specific events that may occur at random, unforeseen times. If the event goes unreported, or if a person is not around to watch each feed at every moment, important moments may go completely unnoticed, or in the case of an emergency, addressed far too late.

Additionally, when multiple cameras are used in a single location, having to switch views between each view may be unduly burdensome, and may even cause the problems discussed above. For instance, a clever wrongdoer may be able to avoid detection by focusing on locations that can only be monitored by a single camera at a time, relying on the high likelihood that an administrator is only viewing a single streaming feed from a single camera.

Accordingly, there is a need for systems and methods for conducting surveillance using multiple streaming feeds. In one embodiment, a system may be disclosed. The system may comprise a first device that includes a first camera operable to capture first video data, and a first microphone operable to capture first audio data. The system may also include a second camera that includes a second camera operable to capture second video data, and a second microphone operable to capture second audio data. Additionally, a central administrative device may include communications circuitry, a display screen, and a processor operable to receive, from the first device, a first streaming feed captured by the first camera; receive, from the second device, a second streaming feed captured by the second camera; display, on the display screen, the first video data; detect, based on the second streaming feed, the occurrence of an event; display, based on the occurrence of the event, the second video data on the display screen; store, in memory, data representing the second streaming feed; and send a first communication to the second device.

In some exemplary embodiments, a team of doctors may wish to see when a patient recovering from surgery is rising from their bed in direct contradiction to the doctors' orders, and may also wish to communicate with the patients to ensure the patients' compliance. In other scenarios, police officers and military soldiers may wish to better communicate their visuals to each other. For instance, each soldier may be equipped with a device that includes a camera and a microphone. In some embodiments, a soldier may encounter an event, such as an explosion or a conflict with another person. As such, it may be desirable for a system to detect the event, capture images of the event, and transmit those images to other devices in the system so that other soldiers have as much information as possible in order to adequately respond to the event.

In another embodiment, a system may be disclosed. The system may comprise a first device that includes a first camera operable to capture first video data, and a first microphone operable to capture first audio data. The system may also include a second camera that includes a second camera operable to capture second video data, and a second microphone operable to capture second audio data. Additionally, a central administrative device may include communications circuitry, a display screen, and a processor operable to receive, from the first device, a first streaming feed captured by the first camera; receive, from the second device, a second streaming feed captured by the second camera; and display, on the display screen, composite video data that includes both the first video data and the second video data, where the first video data and the second video data occupy the same space within the display screen. As such, a location may be monitored from multiple viewpoints and displayed on a screen in a composite video that shows the location at one or more of the viewpoints, providing a comprehensive view of the location.

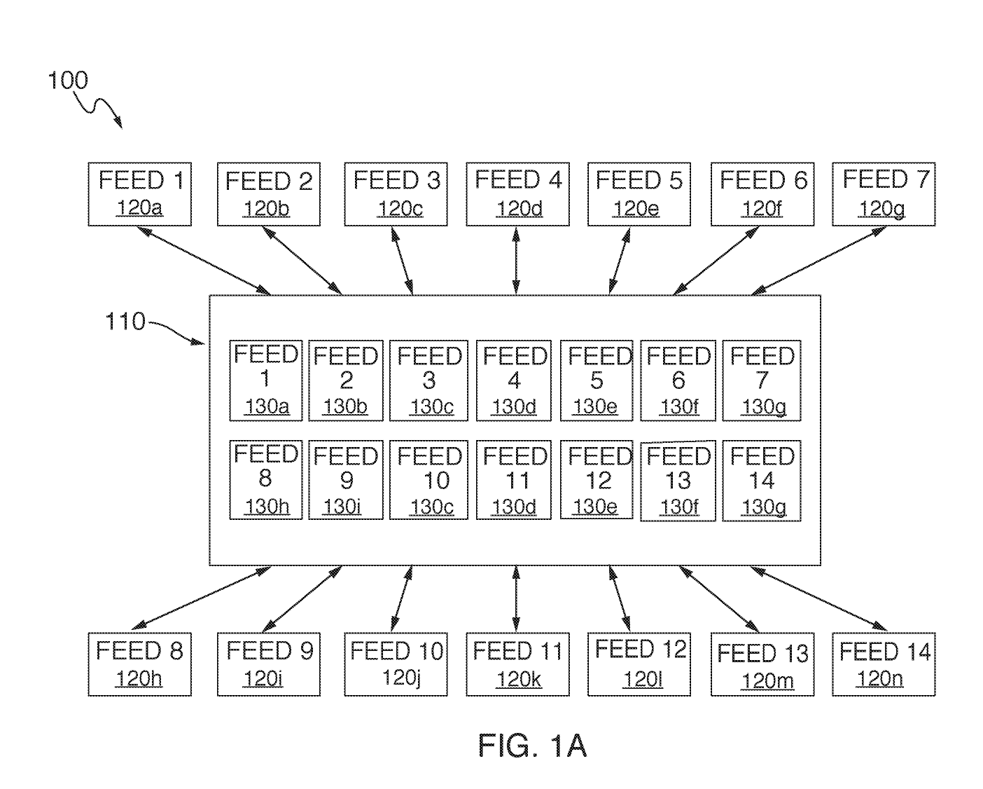

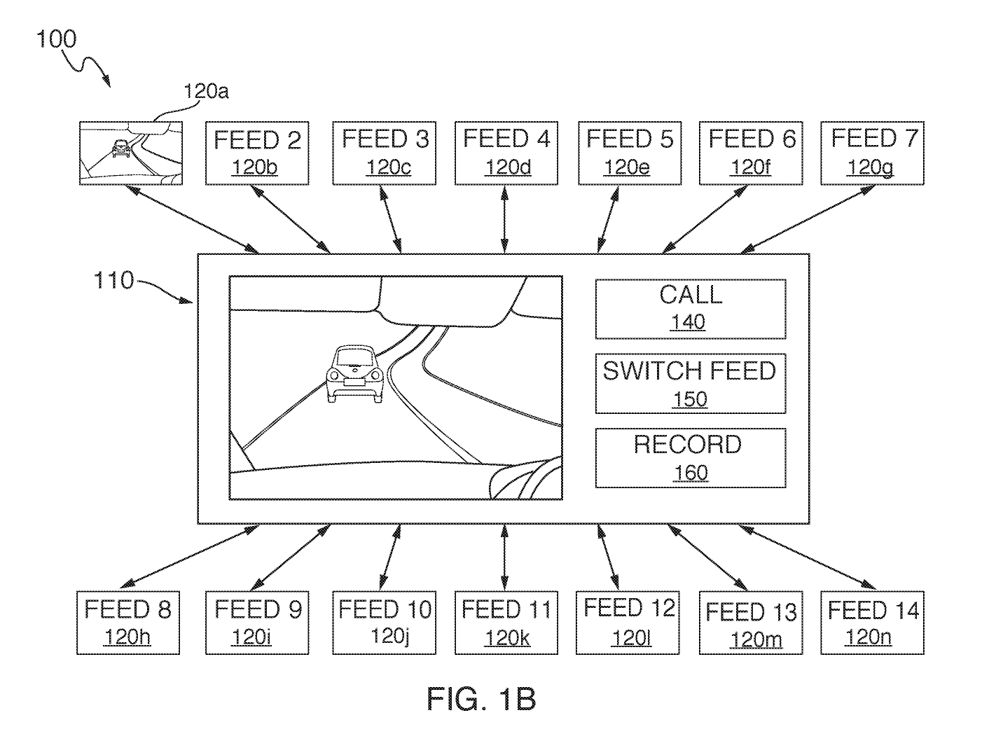

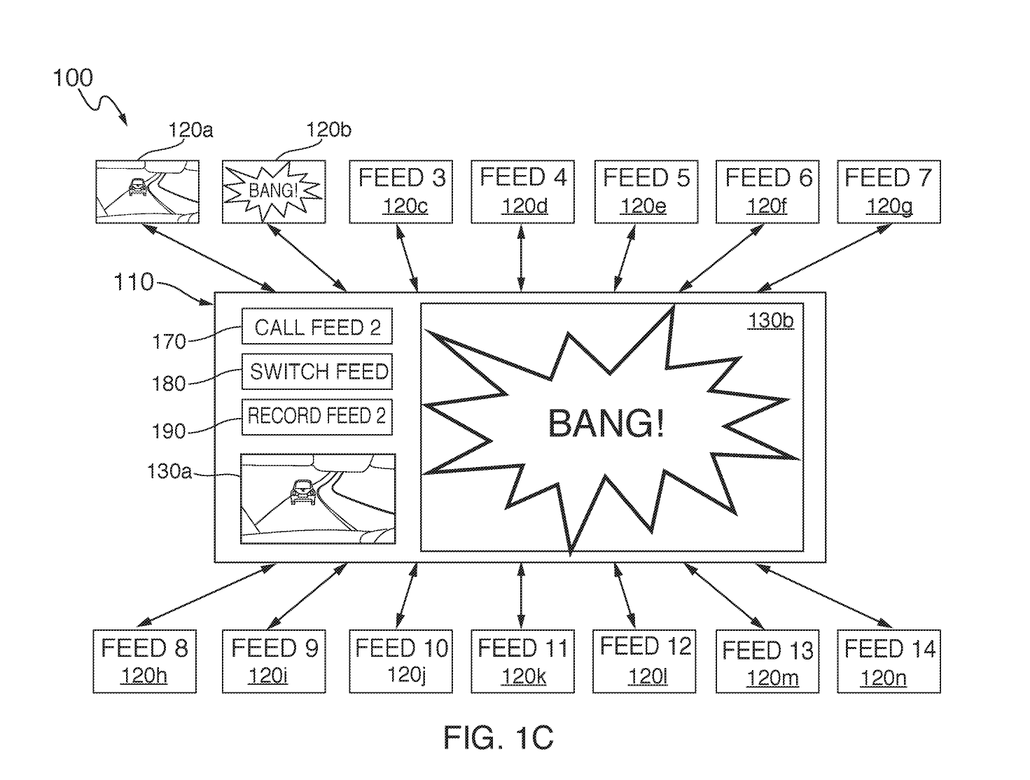

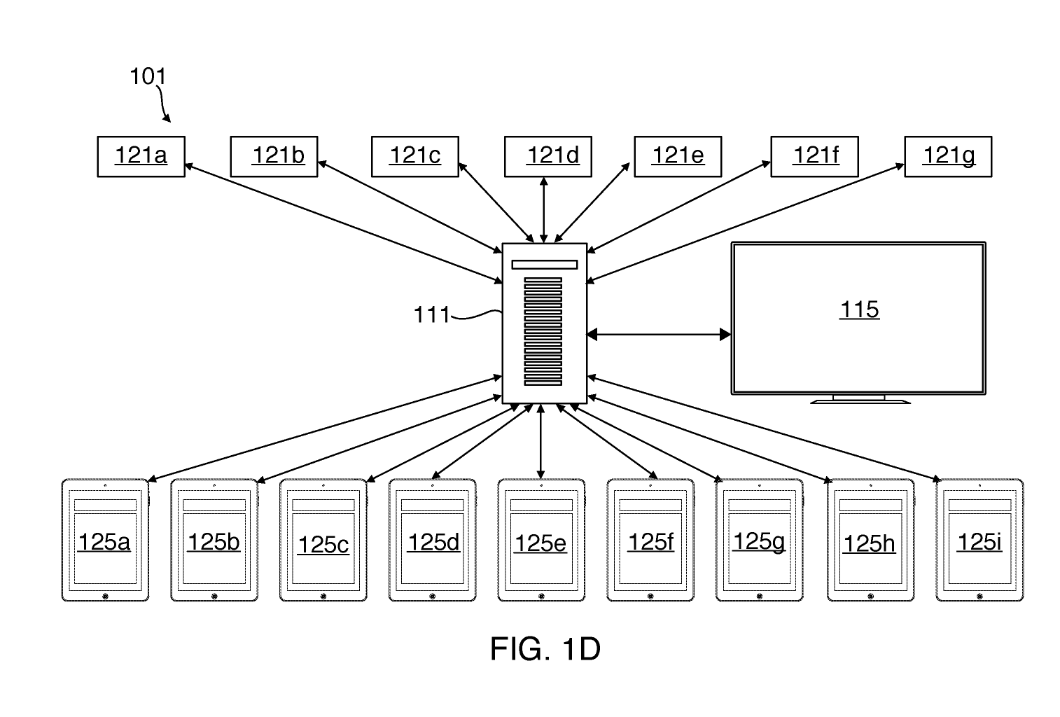

FIG. 1A is a schematic view of an illustrative communications system in accordance with various embodiments. In some embodiments, a communications system may facilitate communications between user devices. Communications system 100 may include at least one server that can be any suitable server for facilitating communications between two or more users devices. For example, the server may include several interconnected computers running software to control communications.

Communications system 100 may include several user devices 120a-120n that capture images, videos, and audio and transmit streaming feeds 130a-130n to a central administrative device 110. The server may be coupled to the user devices through any suitable network. For example, the server may be coupled with the user devices through Wi-Fi (e.g., a 802.11 protocol), Bluetooth®, radio frequency systems (e.g., 900 MHz, 1.4 GHz, and 5.6 GHz communication systems), cellular networks (e.g., GSM, AMPS, GPRS, CDMA, EV-DO, EDGE, 3GSM, DECT, IS-136/TDMA, iDen, LTE or any other suitable cellular network or protocol), infrared, TCP/IP (e.g., any of the protocols used in each of the TCP/IP layers), HTTP, BitTorrent, FTP, RTP, RTSP, SSH, Voice over IP (“VOIP”)), any other communications protocol, or any combination thereof. Each of the user devices may include an electronic device (e.g., a personal computer or a personal communications system). In some embodiments, each user device 120a-120n may correspond to a single user. For example, a first user device 120a may correspond to a first user and a second user device 120b may correspond to a second user. The server may control communications between two or more of the user devices.

Each user device 120a-120n may provide outputs to a user and receive inputs from the user when facilitating communications. For example, user device 120a may include one or more output interfaces (e.g., display screen or audio output) for providing communication outputs to a user, such as a user operating user device 120b or a user/administrator operating device 110 and one or more input interfaces (e.g., a controller, joystick, keyboard, or mouse) for receiving communication inputs from a user.

FIG. 1A may, in some embodiments, include an administrative device 110. Device 110, in some embodiments, may correspond to any electronic device or system. Various types of devices include, but are not limited to, portable media players, cellular telephones or smart phones, pocket-sized personal computers, personal digital assistants (“PDAs”), desktop computers, laptop computers, tablet computers, and/or electronic accessory devices such as smart watches and bracelets. In some embodiments, however, device 110 may also correspond to a network of devices.

Device 110, in some embodiments, may include a display screen, memory, one or more processors, input circuitry, and output circuitry. Persons of ordinary skill in the art will recognize that device 110 may include any number of components, and one or more additional components or modules may be added or omitted without deviating from the scope of the present disclosure. Additionally, one or more components may be combined or separated, and multiple instances of various components are also possible, however only one of each component is shown within device 200 for simplicity.

The display screen may include any suitable mechanism and/or component for displaying inputs from a user or displaying outputs from the device 110. In some embodiments, the display screen may work with input circuitry and output circuitry. The display screen may be any size and may be located on one or more regions/sides of device. For example, the display screen may fully occupy a first side of device 110, or may occupy a portion of the first side. Various display types may include, but are not limited to, liquid crystal displays (“LCD”), monochrome displays, color graphics adapter (“CGA”) displays, enhanced graphics adapter (“EGA”) displays, variable graphics array (“VGA”) displays, or any other display type, or any combination thereof. In some embodiments, the display screen may be a touch screen and/or an interactive display. In some embodiments, the touch screen may include a multi-touch panel coupled to a processor. In some embodiments, a display screen may be a touch screen and may include capacitive sensing panels. In some embodiments, a display may also correspond to a component of an input interface, as it may recognize touch inputs.

Memory may include any suitable form of memory, such as cache memory, semi-permanent memory (e.g., RAM), or any other memory type, or any combination of. In some embodiments, memory may be used in place of and/or in addition to an external memory or storage unit or device for storing data on device 110. Memory may also include, or may correspond to, one or more storage mediums. Various types of storage mediums may include, but are not limited to, hard-drives, solid state drives, flash memory, permanent memory (e.g., ROM), or any other storage type, or any combination thereof. Any form of data or content may be stored within storage memory, such as photographs, music files, videos, contact information, applications, documents, or any other file, or any combination thereof.

Processor(s) may include any suitable processing circuitry, such as one or more processors, capable of controlling the operations and functionality of device 110. In some embodiments, processor(s) may facilitate communications between various components within device 110. For example, processor(s) may cause output circuitry to perform an associated output in response to one or more inputs being received by input circuitry. Processor(s) may also run an operating system for device 110, applications resident on device 110, firmware applications, media application, and/or any other type of application, or any combination thereof functioning on, or in conjunction with, device 110.

Input circuitry may include any suitable mechanism and/or component for receiving inputs from a user operating device 110. In some embodiments, input circuitry may operate through the use of a touch screen and/or an interactive touch sensitive display screen. For example, input circuitry may operate through the use of a multi-touch panel coupled to processor(s), and may include one or more capacitive sensing panels. In some embodiments, input circuitry may also correspond to a component or portion of output circuitry which also may be connected to a touch sensitive display screen. For example, in response to detecting certain touch inputs, input circuitry and processor(s) may execute one or more functions for device 110 and/or may display certain content using output circuitry.

Output circuitry may include any suitable mechanism or component for generating outputs to a user operating device 110. Output circuitry may operate a display screen, and may be any size or shape, and may be located on one or more regions/sides of device 110. For example, output circuitry may operate a display screen that may fully occupy a first side of device 110. Output circuitry may also operate a display screen that may only occupy a portion of a first side of device 110. In some embodiments, output interface may include one or more speaker. Speakers, as used herein, may correspond to any suitable mechanism for outputting audio signals. For example, speakers may include one or more speaker units, transducers, or array of speakers and/or transducers capable of broadcasting audio signals and audio content to a room where device 110 may be located. In some embodiments, speakers may correspond to headphones or ear buds capable of broadcasting audio directly to a user.

In some embodiments, device 110 may correspond to one or more devices. For instance, in some embodiments, multiple streaming feeds may be received from multiple user devices, which may be transmitted to a server from which any device with the appropriate permissions may receive the streaming feeds. In some embodiments, a predetermined relationship may be established between multiple user devices such that streaming feeds received from one or more devices may be transmitted directly to any other user device having the appropriate permissions at one or more users' request. As an example, 500 users may operate a user device that may transmit a streaming feed. Each user device may also include an interface that allows a user to select one or more other user devices from which to receive a transmitted streaming feed. As such, any user within a large scale group of users operating individual user devices may monitor each others' feeds.

In some embodiments, in order to ensure that adequate bandwidth is distributed throughout a system, to minimize data usage, and/or to allocate data usage, data from a streaming feed may be transmitted using one or more modes of communication. For instance, an instant ready-on mode of communication may include a minimal amount of communication such that a communications channel is established between a user device operating via the instant ready-on mode of communication and a server. Using the instant ready-on mode of communication, a user device may not transmit any video data at all, but rather may transmit as much data necessary to maintain a communications channel with a server, and can be quickly upgraded to a higher level mode of communication that would require more data to be transmitted at a much higher rate than at the instant ready-on mode of communication.

For instance, a second mode of communication may include an intermediate mode of communication. The intermediate mode of communication may include intermittent transmission of images, and/or transmission of low-resolution images, low-resolution videos at a low frame rate, audio without video data, and/or some combination thereof.

In some embodiments, a third mode of communication may include an active mode of communication. The active mode of communication may include robust communications, such as high definition, high frame rate videos, high-resolution images and video data, high quality audio, and/or some combination thereof. In some embodiments, where the need arises (e.g., the occurrence of a specific event), an instant ready-on mode of communication or and intermediate mode of communication may be upgraded to an active mode of communication.

In some embodiments, a mode of communication may vary based on specific user inputs. For instance, if a user were to alter the size of a display on a user device from a smaller size to a larger size, a mode of communication may change from, for instance, an instant ready-on mode of communication to an intermediate or active mode of communication. Conversely, if a user were to reduce the size of a display on a user device, the mode of communication may downgrade from, for instance, an active mode of communication to an intermediate or instant ready-on mode of communication.

In some embodiments, a server may receive data (e.g., audio, image, and/or video data) captured by one or more remote cameras in the active mode of communication, record that data, and then transmit that data to one or more devices (e.g., device 110 of FIGS. 1A-1B) using any mode of communication disclosed herein as desirable. For instance, as stated above, a mode of communication through which data is transmitted to a user device may be adjusted based on the user's selected display size. Further, a mode of communication may be adjusted by user preferences, or other inputs entered by a user.

FIG. 1B is an illustrative diagram of a communications system in accordance with various embodiments. In some embodiments, communications system 100 receives streaming feeds 130a-130n from devices 120a-120n. As shown above with respect to FIG. 1A, device 110 may display streaming feeds 130a-130n on a single display screen. However, in various scenarios, it may be impractical to display every streaming feed on a single display screen, even if every streaming feed were being transmitted via an instant ready-on mode of communication and/or an intermediate mode of communication. For instance, by displaying streaming feeds 130a-130n at once on a single display screen, the size of a streaming feed may be smaller than they would be if that streaming feed were the only streaming feed displayed on a display screen of device 110. As such, a level of detail may not be possible if each streaming feed must share space on a display screen of device 110, rather than device 110 being able to view only a single streaming feed, which can occupy all of the space of a display screen of device 110.

As such, in an exemplary embodiment disclosed in FIG. 1B, device 110 may only display streaming feed 130a and include options for navigating between streaming feeds and/or interacting with specific devices, such as a call icon 140 that allows an administrator to communicate with device 120a, a switch feed icon 150 that allows an administrator to switch the focus of its display to view any of streaming feeds 130b-130n (as shown in FIG. 1A), and a record icon 160 for recording data displayed in streaming feed 130a. In some embodiments, upon selecting record icon 160, visual and/or audio data captured by one or more cameras and/or microphones of one or more of devices 120a-120n may be recorded as of the instant the record icon 160 is selected. Additionally, the mode of communication may be upgraded to an intermediate mode of communication or an active mode of communication.

In some embodiments, devices 120a-120n may record a predetermined amount of data for a given time interval, and delete the recorded data upon determining that the record icon 160 is not selected. For instance, device 120a may continuously record 30 seconds of visual and audio data, so that upon an administrator selecting record icon 160, visual and/or audio data captured by device 120a as of thirty seconds prior to the administrator selecting record icon 160 may be recorded and transmitted to administrative device 110. This may allow an administrator to see events leading up to the administrator's decision to record the remainder of the streaming feed, so that the administrator does not miss any of the vital information that may have been shown by streaming feed 130a prior to the administrator deciding to record video fee 130a.

FIG. 1C is another illustrative diagram of a communications system, in accordance with various embodiments. As shown in FIG. 1B, it may be desirable to display a single streaming feed at a time in order to focus one's attention on a single object, and additionally view the streaming feed at a greater level of detail than would be possible on a smaller display (e.g., where there are over a dozen other streaming feeds on the display).

As such, as shown in FIG. 1C, one of devices 120a-120n, device 110, a server, or some other components of system 100 may detect the occurrence of an event. An event includes any occurrence that may signal a need to focus on a streaming feed not currently viewed on the display screen of device 110, including, but not limited to, a loud noise, a sudden change in brightness from visual data captured by a device, the appearance of one or more human and/or nonhuman body parts within a streaming feed, or sudden movements captured and displayed within a streaming feed.

In some embodiments, the occurrence of an event may cause a streaming feed to become the only streaming feed displayed on a display screen of device 110, and/or upgrade the mode of communication to an intermediate mode of communication or an active mode of communication. In some embodiments, a streaming feed currently being displayed may be reduced in size while the streaming feed through which an event is captured becomes prominently displayed on the display screen of device 110. For instance, in FIG. 1C, an explosion may be captured by device 120b. Accordingly, although streaming feed 130a may be prominently displayed on a display screen of device 110, upon detecting the explosion, streaming feed 130b may be displayed on a display screen of device 110 and transmitted via an active mode of communication, along with a minimized display of streaming feed 130a (which may be transmitted at an instant ready-on mode of communication or intermediate mode of communication), an option 170 to communicate with streaming feed 130b, an option 180 to switch streaming feeds, or an option 190 to record streaming feed 130b in instances in which system 100 is not set to automatically begin recording the relevant streaming feed upon the occurrence of an event.

As noted above, devices 120a-120n may automatically record and erase data captured by each device unless prompted to record captured data. Upon the occurrence of the prompt (which in this case is the event), a predetermined amount of data captured prior to the prompt may be recorded and transmitted to device 110, so that an administrator may view the occurrences leading up to the event.

In some embodiments, each device 120a-120n may be may be capable of receiving one or more of streaming feeds 130a-130n. For instance, upon an occurrence of an event, a notice may be sent to each device 120a-120n such that each device receives visual data captured by the device that originally captured the event. For instance, a police officer may view a suspect and use device 120b to capture an image of the suspect, who quickly disappears from that officer's view. Each officer using devices 120a and 120c-120n may see on a display screen of their respective device the image captured by device 120b and therefore be able to identify the suspect.

FIG. 1D is an illustrative diagram of a system for displaying multiple streaming feeds in an interactive presentation, in accordance with various embodiments. System 101 may include multiple streaming feeds 121a-121g that are provided via server 111 to display screen 115 and devices 125a-125i.

In some embodiments, user devices 121a-121g may be one or more user devices that include one or more cameras and one or more microphones capable of capturing images and audio signals, respectively. Those devices may further include communications circuitry capable of transmitting video streams representing those images and audio representing those audio signals to server 111. In an alternative embodiment, devices 121a-121g may be configured to communicate directly with display screen 115 and/or devices 125a-i. For instance, devices 121a-121g may be represented by an identifier. Any device (e.g., display screen 115 and/or device 125a) that sends a data representing a request to receive visual data and/or audio data from one or more of devices 121a-121g may enter into a communications session that allows for the transmission of the requested visual and/or audio data.

In one or more embodiments, in order to, for instance, control bandwidth, each of devices 121a-121g, 125a-125i, and/or server 111 may be configured to manage the number of devices and quality of data transmitted between one or more of devices 121a-121g and 125a-125i. For instance, each streaming feed received from devices 121a-121g may be transmitted from devices 121a-121g via an instant ready-on mode of communication. As such, minimal bandwidth is being transmitted from a single device at a time. If the number of devices (e.g., devices 125a-125i) seeking data from a streaming feed transmitting device (e.g., devices 121a-125g) does not exceed a predetermined threshold, the quality of streaming feeds may increase to an intermediate mode of communication or an active mode of communication.

In order to further describe the present invention, an exemplary embodiment is described. In such an exemplary embodiment, a large presentation event may be in progress. Each of devices 121a-121g may be a camera and/or microphone located in close proximity to a police officer (e.g., on the officer's person, on a vehicle assigned to the officer, on a robotic device capable of identifying and accompanying the officer, etc.).

During the presentation, a plurality of participants may operate devices 125a-125i to observe the officers. Each of devices 125a-125i may be used to access each of devices 121a-121g simultaneously or individually at a time. For instance, each device 125a-125i may include a display screen. Each streaming feed transmitted from devices 121a-121g may be viewed via an instant ready-on mode of communication as small images on a single display screen, allowing a participant operating, for instance, device 125a to view each officer at a time. If a particular officer's device, for instance device 121a, piques the participant's interest, the participant may select the particular image corresponding to the streaming feed transmitted from device 121a to enlarge the image received from device 121a and remove feeds received from other devices 121b-121g. The mode of communication between device 125a and device 121a might then be upgraded to an active mode of communication, such that device 125a begins to receive robust streaming video data and audio data from device 121a.

Further, one or more of devices 125a-125i may include administrative permissions to determine the content of display screen 115. For instance, continuing the example provided above, the participant operating device 125a may determine that the activity recorded and transmitted by device 121a is of particular importance, and should be displayed and discussed among all participants. Accordingly, a request may be received from device 125 to display the streaming feed received from device 121a on display screen 115. In another embodiment, device 125a may additionally, or alternatively, overwrite the displays of devices 125b-125i such that the streaming feed received from device 121a is transmitted to each of those devices.

Other examples of device 121a include, but are not limited to, CCTV devices distributed throughout a given location (e.g., a metropolitan area, a building, etc.), vehicular dashboard cameras, and cameras installed on user devices (e.g., webcams, cellular phone cameras, etc.). In various embodiments, one or more of devices 121a-121g and 125a-125i may be connected to server 111, display screen 115, and/or one another.

In an exemplary embodiment, system 101 may be configured to follow a particular individual. For instance various cameras may be distributed throughout an area, making it possible to follow a particular individual throughout the area. As such, server 111 may include a database of images, and a processor capable of comparing images captured by cameras located on devices 121a-121g to images stored in memory in order to identify individuals. Thus, one or more of devices 125a-125i may be used to monitor a streaming feed that focuses on a single individual as that individual traverses the area.

For instance, in a building, various cameras may be located in one or more rooms. If a user operating device 125a wishes to monitor that individual, the user use device 125a to send instructions to server 111 and/or one or more of devices 121a-121g to only transmit streaming feeds from devices 121a-121g that include captured images of the individual of interest. Accordingly, at a given point in time, the individual may be in a room within the field of view of a camera located on device 121a, and therefore device 125a may receive a streaming feed from device 121a. As that individual leaves the room, however, the individual may no longer be in the field of view of the camera on device 121a. Rather, the individual may then be in a hallway or another room within the field of view of a camera located on device 121b. As such, the streaming feed received by device 125a may immediately switch such that the video stream received by device 125a is received from device 121b. If the individual then switches to a location within the field of view of a camera located on device 121c, the streaming feed received by device 125a will then switch such that the video stream received by device 125a is then received from device 121c, and so on.

In some embodiments, the individual may be captured by multiple cameras. For example, as an individual leaves one room while being captured by a camera on device 121a, a camera on device 121b may also be capturing visual data of that individual and server 111 may have identified the appearance of the individual in an image captured by device 121b. Accordingly, server 111 may need to determine which streaming feed to display on a device configured to follow the individual using devices 121a-121g.

In one embodiment, server 111 may accomplish this by using facial and/or body recognition techniques to initially identify the individual using device 121a. After identifying the individual, server 111 may continuously apply facial and/or body recognition techniques to determine a value corresponding to the prominence of the individual within the image(s) captured using device 121a. For instance, if a clear image of the individual's face is detected, then a value of 89% may be assigned to the captured image of the individual. As the individual leaves the room, the individual's back might be turned. While body recognition techniques may determine the identity of the user, the lack of facial recognition may reduce the value of prominence to 54%. As the individual enters another room and/or hallway and an image of the individual is captured using device 121b, a second value may be assigned that corresponds to the prominence at which the individual is displayed in the image captured using device 121b. If that value, at that particular instant, exceeds the value assigned to the image captured using device 121a (e.g., the user's face is prominently visible in the image captured using device 121b, and thus the value exceeds 54%), then server 111 may determine that the streaming feed no longer display visual and/or audio data received from device 121a, but rather display visual and/or audio data received from device 121b.

In some embodiments, system 101 may determine that visual data from one device should be displayed in a streaming feed, while audio data from another device should be presented. For instance, continuing the example of the preceding paragraph, a microphone located on device 121b may be malfunctioning. Accordingly, server 111 may compare the quality of audio data received from devices 121a and 121b. If the quality of audio data received from device 121a exceeds the quality of audio data received from device 121b, then although the visual data received from 121b is displayed in the streaming feed, the accompanying audio data to the streaming feed may be received from device 121a.

In another exemplary embodiment, system 101 may be configured to determine specific occurrences that may cause a particular device to be “spotlighted” such that the particular device automatically sends audio and/or visual data to display screen 115 and/or one or more of devices 125a-125i. For instance, devices 121a-121g may correspond to body cameras worn by police officers. Users operating devices 125a-125i may be monitoring one or more police officers via one or more of devices 121a-121g. At one point however, system 101 may determine that a particular officer wearing device 121a may be engaged in a conflict, and may automatically override devices 125a-125i and/or display screen 115 such that video and/or audio data received from device 121a is prominently displayed on one or more display screens of one or more of devices 125a-125i and/or display screen 115.

Examples of occurrences detected by system 101 that would cause such a situation may further include, but would not be limited to a sound of a gunshot (e.g., audio data received from device 121a that matches the sound profile of audio stored in memory known to correspond to a gunshot), high stress environment (e.g., audio data received from device 121a that matches the sound profile of audio stored in memory known to correspond to yelling, aggressive tone of voice, fatigue, crying, etc.), sounds of danger (e.g., audio data received from device 121a that matches the sound profile of audio stored in memory known to correspond to a vehicle crash, breaking glass, a loud thud, etc.), appearance of a particular item (e.g., visual data received from device 121a that substantially matches an image stored in memory known to correspond to an item, such as a weapon), appearance of an individual of interest (e.g., visual data received from device 121a that substantially matches an image stored in memory known to correspond to a particular individual), etc.

User devices 125a-125i may send various instructions to various other devices throughout system 101. For instance, as stated above, user device 125a may send instructions to display screen 115 to display video data and/or audio data received from device 121a. As another example, device 125a may establish a two-way communications session with any or all of devices 125b-125i and 121a-121g such that audio and/or video communications may be transmitted from device 125a to one or more of devices 121a-121g and 125a-125i.

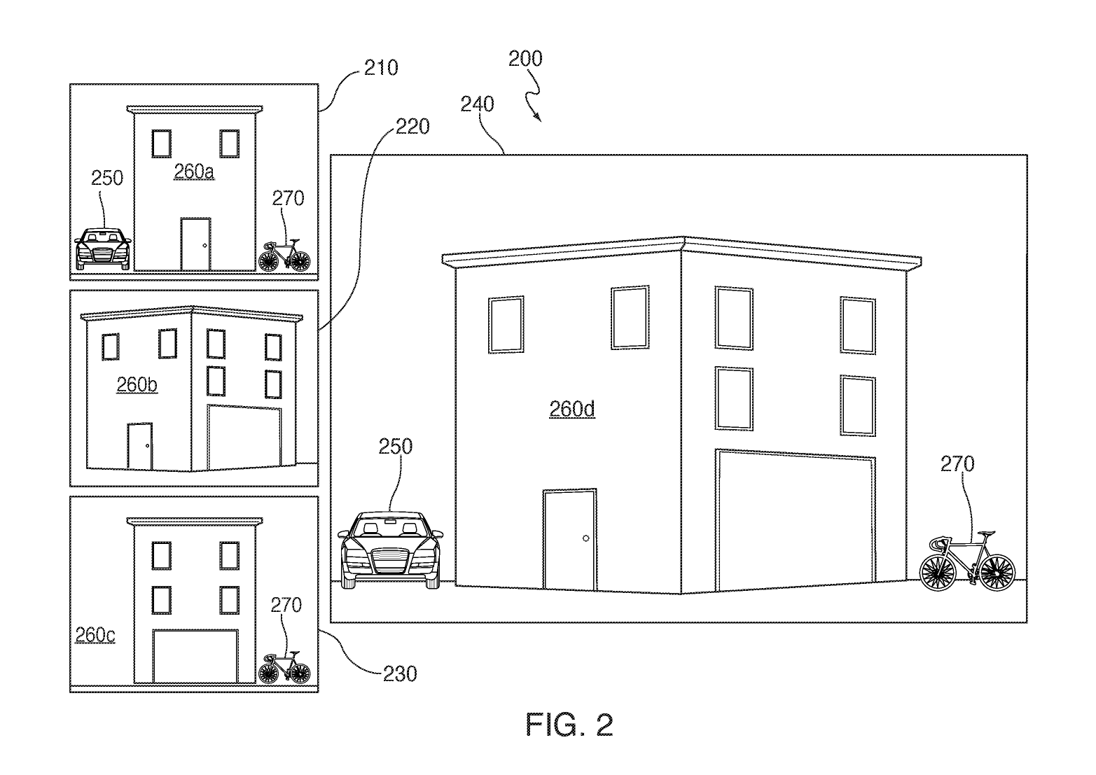

FIG. 2 is an illustrative diagram of a composite display, in accordance with various embodiments. In some embodiments, FIG. 2 may include streaming feeds 210-230 and composite video 240. Each of streaming feeds 210-230 and composite video 240 may display different perspectives 260a-260d of an image of a building. In some embodiments, streaming feeds 210-230 may be captured visual data (e.g., images and/or videos captured by a drone) of the building. In some embodiments, each perspective may convey different information to a user, such that a user may only receive all of the necessary information possible by viewing each streaming feed. For instance, a car 250 next to the building may only be shown in streaming feed 210 because streaming feed 210 may be limited to a front perspective view 260a of the building. In streaming feed 220, nothing on a side or rear of the building may be disclosed because only a corner perspective view 260b may be shown. Additionally, a bike 270 may only be visible using a side perspective view 260c of the building in streaming feed 230. However, by combining each streaming feed into a composite video 240, a panoramic view 260d may provide a more comprehensive view of the building, car 250, and bike 270, allowing a user to see all of the necessary elements of an object captured by three different devices from three different perspectives in a single streaming feed.

In some embodiments, it may be impracticable or even impossible to view all streaming feeds simultaneously. Accordingly, it may be desirable to combine streaming feed

It should be appreciated that the various embodiments described above can be implemented by software, but can also be implemented in hardware or a combination of hardware and software. The various systems described above can also be embodied as computer readable code on a computer readable medium. The computer readable medium can be any data storage device that can store data, and that can thereafter be read by a computer system. Examples of computer readable mediums include read-only memory, random-access memory, CD-ROMs, DVDs, magnetic tape, and optical data storage devices. The computer readable medium can also be distributed over network-coupled computer systems so that the computer readable code is stored and executed in a distributed fashion.

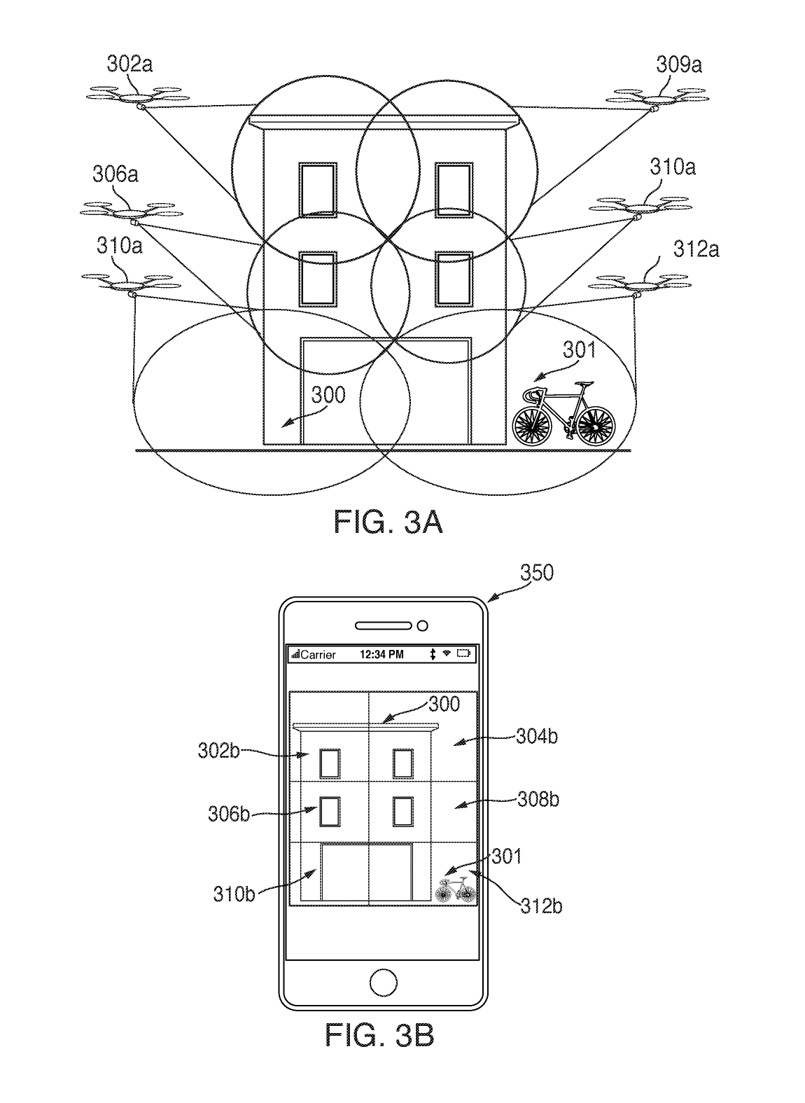

FIG. 3 is an illustrative diagram of a system for displaying a composite view, in accordance with various embodiments. In various embodiments, FIG. 3A includes several aerial cameras 302a-312a capturing images and/or video data of a building 300 and nearby bicycle 301. In the exemplary embodiment of FIG. 3A, images and/or video data representing each surface of building 300 and bicycle 301 are being captured by at least one of cameras 302a-312a. As shown in FIG. 3A, cameras 302a-312a are suspended in air (e.g., drones) and are relatively fixed in position in relation to one another, such that each of cameras 302a-312a capture a particular portion of target building 300.

In an exemplary embodiment as shown in FIG. 3B, streaming feeds from images and/or video data captured by cameras 302a-312a may be displayed on a display such as the display of device 350. In the embodiment of FIG. 3B, the display is separated into six sections such that, for example, section 302b corresponds to images captured by camera 302a, section 312b corresponds to images captured by camera 312a, and so on. It should be noted that the lines displayed on the display of device 350 are merely illustrative, and may not necessarily be present, or visible, on a display screen. In some embodiments, a user may wish to view other parts of building 300. For instance, a user may wish to view the rear of building 300. Accordingly, a user may enter an input representing a request to view the rear of building 300, and each camera 302a-312a may adjust their physical locations (e.g., by moving to the rear of building 300 in unison with one another) in order to capture images and/or video data relating to the rear of building 300, and a display of device 350 may accordingly display such data.

The above-described embodiments of the invention are presented for purposes of illustration and not of limitation.

What is claimed is:

1. A method comprising:
receiving, from a first device, a first streaming feed comprising first audio data and first video data;
receiving, from a second device, a second streaming feed comprising second audio data and second video data;
displaying, on a display screen, the first video data;
detecting, based on the second streaming feed, an occurrence;
displaying, based on detecting the occurrence, the second video data on the display screen; and
storing, in memory, data representing the second streaming feed.

2. The method of claim 1, further comprising sending a first communication to the second device.

3. The method of claim 1, wherein the occurrence comprises receiving an instruction from a third device to display the second video data on the display screen.

4. The method of claim 3, further comprising:
displaying, prior to detecting the occurrence, the second video data on a user display of the third device using at least one of an instant ready-on mode of communication and an intermediate mode of communication, and displaying, based on the occurrence, the second video data on the display screen using an active mode of communication.

5. The method of claim 1, wherein the occurrence comprises determining that the second video data comprises at least one of:
the appearance of a particular individual; and
the appearance of a particular item.

6. The method of claim 5, wherein displaying the first video data is based on the appearance of the individual, and the occurrence further comprises at least one of:
detecting a disappearance of the individual from the first video data; and
assigning a first value corresponding to a first prominence of the individual displayed within the first video data, assigning a second value corresponding to a second prominence of the individual displayed within the second video data, and determining that the second value is greater than the first value.

7. The method of claim 1, wherein the occurrence comprises determining that the second audio data substantially matches the sound profile of specific audio data stored in memory.

8. A system, comprising:
a first device comprising a first camera operable to capture first video data, and a first microphone operable to capture first audio data;
a second device comprising a second camera operable to capture second video data, and a second microphone operable to capture second audio data;
communications circuitry;
memory;
a display screen; and
a processor operable to:
receive, from the first device, a streaming feed captured by the first camera;
receive, from the second device, a streaming feed captured by the second camera;
display, on the display screen, the first video data;
detect, based on the second streaming feed, an occurrence;
display, based on the occurrence, the second video data on the display screen; and
store, in the memory, data representing the second streaming feed.

9. The system of claim 8, wherein the communications circuitry is operable to send a first communication to the second device.

10. The system of claim 8, wherein the occurrence comprises receiving an instruction from a third device to display the second video data on the display screen.

11. The system of claim 10, further comprising:
displaying, prior to detecting the occurrence, the second video data on a user display of the third device using at least one of an instant ready-on mode of communication and an intermediate mode of communication, and displaying, based on the occurrence, the second video data on the display screen using an active mode of communication.

12. The system of claim 8, wherein the occurrence comprises determining that the second video data comprises at least one of:
the appearance of a particular individual; and
the appearance of a particular item.

13. The system of claim 12, wherein displaying the first video data is based on the appearance of the individual, and the occurrence further comprises at least one of:
detecting a disappearance of the individual from the first video data; and
assigning a first value corresponding to a first prominence of the individual displayed within the first video data, assigning a second value corresponding to a second prominence of the individual displayed within the second video data, and determining that the second value is greater than the first value.

14. The system of claim 8, wherein the occurrence comprises determining that the second audio data substantially matches the sound profile of specific audio data stored in the memory.

15. A method comprising:
receiving, from a first device, a first streaming feed comprising first audio data and first video data;
receiving, from a second device, a second streaming feed comprising second audio data and second video data;
displaying, on a display screen, composite video data comprising the first video data and the second video data.

16. The method of claim 16, wherein:
the first video data corresponds to a first portion of a target, the first portion being captured by a first camera, and the first video data is displayed on a first section of the display screen; and
the second video data corresponds to a second portion of the target, the second portion being captured by a second camera, and the second video data is displayed on a second section of the display screen.

17. The method of claim 16, wherein the first portion is not captured by the second camera, and wherein the second portion is not captured by the first camera.

18. The method of claim 16, wherein less than a first entirety of the first portion is captured by the second camera, and less than a second entirety of the second portion is captured by the first camera.

19. The method of claim 16, wherein the first camera and the second camera are suspended in air and are substantially fixed in position relative to one another.

20. The method of claim 15, wherein the first video data and the second video data at least partially overlap.
